(19) United States
(12) Patent Application Publication
(10) Pub. No.: US 2020/0151518 A1
(43) Pub. Date: May 14, 2020

(54) REGULARIZED MULTI-METRIC ACTIVE LEARNING SYSTEM FOR IMAGE CLASSIFICATION

(71) Applicant: Purdue Research Foundation, West Lafayette, IN (US)

(72) Inventors: Melba Crawford, West Lafayette, IN (US); Zhou Zhang, Davis, CA (US)

(73) Assignee: Purdue Research Foundation, West Lafayette, IN (US)

(21) Appl. No.: 16/574,073

(22) Filed: Sep. 17, 2019

Related U.S. Application Data
(60) Provisional application No. 62/732,375, filed on Sep. 17, 2018.

(51) Int. Cl. G06K 9/62; G06N 20/00; G06F 17/16

(52) U.S. Cl. CPC G06K 9/6268; G06K 9/6259; G06F 17/16; G06N 20/00; G06K 9/6228

(57) ABSTRACT

A regularized multi-metric active learning (AL) image classification system which includes three main parts. First, a regularized multi-metric learning process is utilized to jointly learn distinct metrics for different types of image features from remotely sensed image data. The regularizer incorporates the unlabeled data based on the neighborhood relationship, which helps avoid overfitting at early stages of AL, when the quantity of training data is particularly small. Then, as AL proceeds, the regularizer is also updated through similarity propagation, thus taking advantage of informative labeled samples. Finally, multiple features are projected into a common feature space, in which a batch-mode AL strategy combining uncertainty and diversity is utilized in conjunction with k-nearest neighbor (kNN) classification to enrich the set of labeled samples.

### CROSS REFERENCE TO RELATED APPLICATION

This application claims priority to U.S. Provisional Patent Application No. 62/732,375 filed Sep. 17, 2018, which is hereby incorporated by reference in its entirety.

### GOVERNMENT RIGHTS CLAUSE

This invention was made with government support under DE-AR0000593 awarded by the Department of Energy. The government has certain rights in the invention.

### BACKGROUND

Hyperspectral sensors have enabled the collection of remotely sensed image data having hundreds of narrow, contiguous bands of the electromagnetic spectrum, thus providing rich spectral detail. The recent development of advanced hyperspectral sensors increases the availability of high spectral and spatial resolution hyperspectral imagery via space-based, airborne, and unmanned aerial vehicle (UAV) platforms. Such imagery has been particularly useful in the field of remote image sensing for land cover classification, since the detailed spectral information enables better discrimination of different land cover types as compared to natural color images or multispectral data. Integration of disparate features (e.g., spectral and spatial features) often provides complementary information that improves classification performance. However, the further increased dimensionality of the input image data exacerbates the high dimensionality problem of hyperspectral data for developing a robust supervised image classifier. Therefore, improvements are needed in the field.

### SUMMARY

According to one aspect, a method of processing remotely sensed input image data is provided, comprising receiving remotely sensed input image data, the input image data comprising a plurality of image features, regularizing the input image data by applying a multimetric heterogeneous multimetric learning (HMML) active learning process which incorporates unlabeled data in the input data based on neighborhood relationships within the input data, and updating similarity matrices in the HMML active learning process by incorporating supervised information in the dataset and iterating said regularizing to again regularize the input image data, revising the image data wherein a set of unlabeled samples having a maximum degree of uncertainty are first considered based on an uncertainty criterion, after which a diversity criterion is applied to select the most informative samples from a resulting contention pool.

This summary is provided to introduce the selection of concepts in a form that is easy to understand the detailed embodiments of the descriptions. The embodiments are then brought together in a final embodiment which described an environment, thereby stressing that each of the embodiments may be viewed in isolation, but also the synergies among them are very significant. This summary is not intended to identify key subject matter or key features or essential features thereof.

### BRIEF DESCRIPTION OF THE DRAWINGS

The above and other objects, features, and advantages of various examples will become more apparent when taken in conjunction with the following description and drawings wherein identical reference numerals have been used, where possible, to designate identical features that are common to the figures, and wherein:

FIG. 1 is a flow diagram illustrating a process for processing remotely sensed image data according to one embodiment.

FIG. 2 is a summarized description of the steps performed in the diagram of FIG. 1.

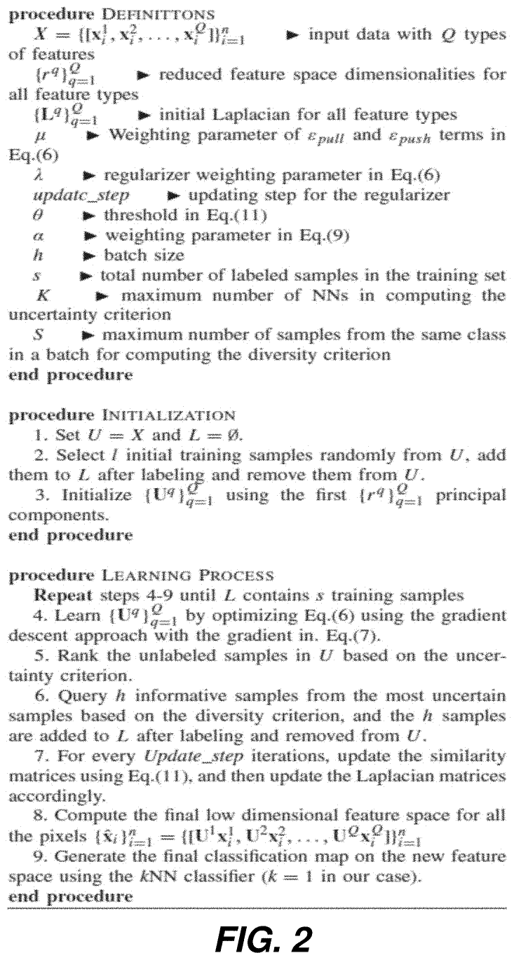

FIG. 3 illustrates a system for processing remotely sensed image data using the process of FIG. 1 according to one embodiment.

### DETAILED DESCRIPTION

The term “drawings” used herein refers to drawings attached herewith and to sketches, drawings, illustrations, photographs, or other visual representations found in this disclosure. The terms “I,” “we,” “our” and the like throughout this disclosure do not refer to any specific individual or group of individuals.

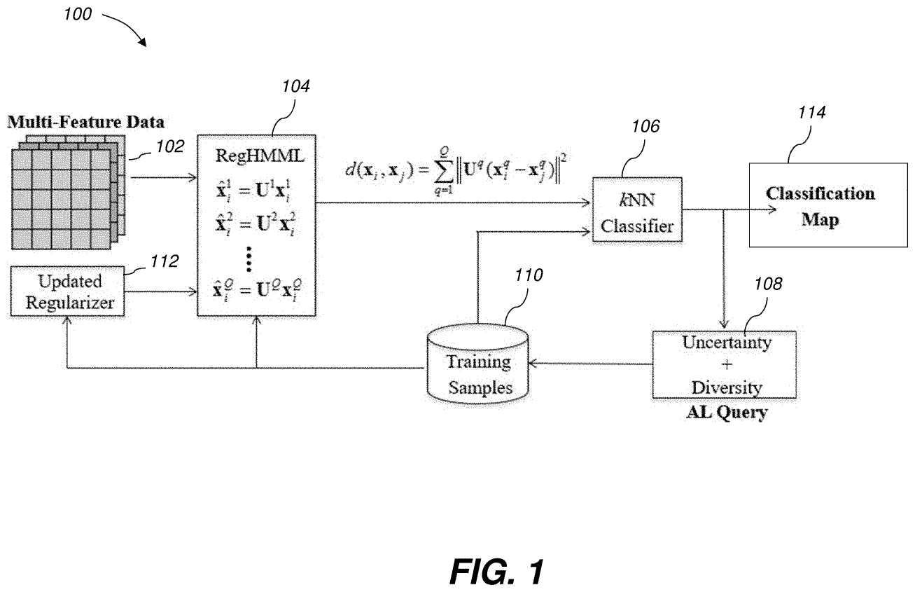

The present disclosure provides and system and method for processing remotely sensed input image data to produce high quality output image maps. The sensed input image data is typically high dimensional data, such as multi/hyperspectral, LiDAR, or RGB+Texture data. The method comprises three main parts, which are illustrated in the flow diagram of FIG. 1. As shown, multi-feature input image data 102 is received and directed to a regularized heterogeneous multimetric learning (HMML) processing block 104. After being processed by the block 104, the data is directed to a kNN classifier block 106. Block 106 refines the regularizer using a kNN classifier using an updated set of similarity matrices which incorporates supervised information from the data set to reflect the real similarity between data pairs. The data is then processed by block 108 which applies an active learning (AL) process wherein a set of unlabeled samples having a maximum degree of uncertainty are first considered based on an uncertainty criterion, after which a diversity criterion is applied to select the most informative samples from a resulting contention pool. The output of block 108 is directed to block 110 where training samples are incorporated and directed again to block 104 and 106, in addition to block 112 which updated the regularizer as shown and discussed further below.

Let X={[xᵢ¹, xᵢ², . . . , xᵢ^{Q}]}ᵢ₌₁ⁿ and denote a set of n samples with Q different types of features, where xᵢ^{q}∈R^{d}^{^{q}} represents the ith sample from the qth feature type and d^{q} is the dimensionality of the corresponding feature space. Similarly, let L={[xᵢ¹, xᵢ², . . . , xᵢ^{Q}], yᵢ}ᵢ₌₁^{l} be a set of training samples, which is constructed by selecting l samples from the set X, with corresponding class labels, and U=be the set of the remaining unlabeled samples, where U={[xᵢ¹, xᵢ², . . . , xᵢ^{Q}]}ᵢ₌^{l+u}. To deal with high dimensional input data X, LMNN, a single type feature strategy, was adapted to a multi-type feature setting and referred to as HMML. The distance between two training samples is defined by considering all the features:

$${\sum }_{q = 1}^{Q} d ( {x}_{i}^{q} , {x}_{j}^{q} ) = {\sum }_{q = 1}^{Q} {‖ {U}^{q} ( {x}_{i}^{q} - {x}_{j}^{q} ) ‖}^{2} \qquad ( 1 )$$

where U^{q}∈R^{r}^{^{q}}^{×d}^{^{q}} corresponds to a transformation matrix for the qth feature type, and r^{q} and d^{q} are the input and output of the dimensionality of the qth feature type respectively. Also, for a labeled sample (xᵢ, yᵢ), we denote (xⱼ, yⱼ) as one of the kNNs of xᵢ with label yⱼ=yᵢ, and (xₗ, yₗ) as any sample with label yⱼ≠yᵢ. Therefore, the two term loss function can be formulated as

$$\begin{matrix}ɛ = ( 1 - μ ) {ɛ}_{pull} + {μɛ}_{push} & ( 2 ) \\ \{ \begin{matrix}{ɛ}_{pull} = {\sum }_{i , j} {\sum }_{q = 1}^{Q} {‖ {U}^{q} ( {x}_{i}^{q} - {x}_{j}^{q} ) ‖}^{2} \\ {ɛ}_{push} = {\sum }_{i , j , l} {[ 1 + {\sum }_{q = 1}^{Q} {‖ {U}^{q} ( {x}_{i}^{q} - {x}_{j}^{q} ) ‖}^{2} - {\sum }_{q = 1}^{Q} {‖ {U}^{q} ( {x}_{i}^{q} - {x}_{j}^{q} ) ‖}^{2} ]}_{+}\end{matrix} & ( 3 )\end{matrix}$$

where [·]₊=max(·,0) is the hinge loss. The term εₚᵤₗₗ acts to pull neighboring samples with the same label closer, while the term εₚᵤₛₕ pushes differently labeled samples further apart. The two terms are combined using a weighting parameter μ. The multiple metrics are coupled via the hinge loss and learned jointly from the training data, thus allowing the information from multiple features to be fused. Note that HMML degenerates to LMNN when Q=1. HMML only exploits the labeled information for feature reduction, which is likely to overfit with a small training set. Incorporating the abundant unlabeled samples into the learning process is important since they can provide information on the underlying data distribution and thus help avoid overfitting. For multi-metric learning, an unsupervised regularizer is constructed as follows:

$$\begin{matrix}\begin{matrix}reg = \frac{1}{2} {\sum }_{q = 1}^{Q} {\sum }_{i , j = 1}^{n} {W}_{ij}^{q} {‖ {U}^{q} ( {x}_{i}^{q} - {x}_{j}^{q} ) ‖}^{2} \\ = {\sum }_{q = 1}^{Q} tr ( {X}^{q} {L}^{q} {X}^{q} {U}^{qT} {U}^{q} )\end{matrix} & ( 4 ) \\ {W}_{ih}^{q} = \{ \begin{matrix}1 , & {x}_{j}^{q} ∈ N ( {x}_{i}^{q} ) \\ 0 , & otherwise \end{matrix} & ( 5 )\end{matrix}$$

For the qth type of feature, in equation (4), tr refers to the trace operator; X^{q}=[xᵢ^{q}, . . . , xₙ^{q}]∈R^{d}^{^{q}}^{×n} represents the sample matrix; L^{q}=D^{q}−W^{q} is a Laplacian matrix; D^{q} is a diagonal matrix whose diagonal elements are computed by

$${D}_{ii}^{q} = {\sum }_{j = 1}^{n} {W}_{jj}^{q} ; {W}^{q} = {[ {W}_{ij}^{q} ]}_{i , j = 1}^{n}$$

is the kNN graph matrix, which represents the similarities between all sample pairs, and N(xᵢ^{q}) denotes the neighborhood of data point Xᵢ^{q} based on the Euclidean metric. Note that W^{q} is asymmetric and Wᵢⱼ^{q}=t. The loss function in equation (2) is augmented by including the proposed relularizer into HMML, and the objective function of RegHMML is then defined as:

ε_{obj}=(1−μ)εₚᵤₗₗ+μεₚᵤₛₕ+λreg (6)

where λ is a tradeoff parameter between the loss function and the regularizer.

In a metric-active learning framework, an important step is to obtain a reduced feature space at each AL iteration. For this purpose, Eq. (6) should be minimized with respect to {U^{q}}_{q=1}^{Q}, and the projection matrix U^{q} should be constrained to be rectangular of size r^{q}×d^{q} with r^{q}<<d^{q}. At each AL iteration, the gradient descendent approach is use d to solve this optimization problem. The gradient with respect to U^{q} is

$$\frac{\partial {ɛ}_{obj}}{\partial {U}^{q}} = 2 ( 1 - μ ) {U}^{q} {\sum }_{i , j = 1}^{n} {C}_{ij}^{2} + 2 μ {U}^{q} {\sum }_{( i , j , l ) ∈ {N}_{m}} ( {C}_{ii}^{q} - {C}_{jj}^{q} ) + 2 λ {U}^{q} {X}^{q} {L}^{q} {X}^{qT} \qquad ( 7 )$$

Where Cᵢⱼ^{q}=(xᵢ^{q}−xⱼ^{q})(xᵢ^{q}−xⱼ^{q})^{T}, and Nₜᵣᵢ represents a set of triples (i, j, l)∈Nₜᵣᵢ that triggers the hinge loss in equation (3). After learning the projection matrix set {U^{q}}_{q=1}^{Q}, kNN classification is performed based on the distance metric defined in equation (1). Therefore, having obtained the projection matrix, a sample with different types of features can be represented in a lower dimensional feature space as \hat{x}ᵢ=Uxⱼ, where U is a block diagonal matrix with {U^{q}}_{q=1}^{Q} as the block entries. The resulting feature space, in which the AL query is applied, is then \hat{x}ᵢ=[U¹xᵢ¹, U²xᵢ², . . . , U^{Q}xᵢ^{Q}].

Next, the regularizer is refined via similarity propagation as follows. In the regularizer, kNN graph based similarities {W^{q}}_{q=1}^{Q} for all feature types are constructed to provide a smoothness measure for data neighborhoods and help avoid overfitting. However, in an AL framework, the fixed unsupervised similarities may not be suitable for the classification task. This is because 1) they may not connect the actual similar sample pairs, e.g., sample within the same class; and 2) unsupervised information becomes less important as more labeled samples are iteratively added into the training set. Therefore, instead of using fixed similarities {W^{q}}_{q=1}^{Q}, the system learns a new set of similarity matrices {\tilde{W}^{q}}_{q=1}^{Q} which can reflect the real similarity between data pairs by incorporating supervised information. Supervised information is information which has been selected by a user as representative as suitable training data. A strong similarity matrix constructed based on the labeled information, is defined as S⁽⁰⁾∈R [symbol] , where Sᵢⱼ⁽⁰⁾=1 for any I and Sᵢⱼ⁽⁰⁾=1 for samples within the same class and zero to all other elements. Therefore, we have the same S⁽⁰⁾ for all types of features. Then, for each feature type, we regard the 1-elements as original positive energies and try to propagate these energies to the 0-elements in S^{(O)}, following the path built in the feature specific weak similarity matrices {W^{q}}_{q=1}^{Q}. For the qth feature type, for example, the similarity propagation can be formulated as

$${S}_{i}^{{q}^{( i + 1 )}} = ( 1 - α ) {S}_{i}^{( 0 )} + α \frac{{\sum }_{j = 1}^{n} {W}_{ij}^{q} {S}_{i}^{{q}^{( i + 1 )}}}{{\sum }_{j = 1}^{n} {W}_{ij}^{q}} \qquad ( 8 )$$

Where Sᵢ [symbol] denotes the ith row of matrix S^{q} at the tth time stamp, and α, restricted by 0<α<1, is a parameter indicating the relative amount of the information from its neighbors and its supervised information. Equation (8) can be written in matrix form as

$${S}^{{q}^{( i + 1 )}} = ( 1 - α ) {S}^{( 0 )} + α {P}^{q} {S}^{{q}^{( i )}} \qquad ( 9 )$$

Where P^{q}=(D^{q})⁻¹W^{q} is the transition probability matrix widely used in Markov random walk models. Since 0<α<1, and the eigenvalues of P^{q} are in [−1, 1], S^{q}^{⁽⁰⁾} converges and its limit can be directly calculated as

$${S}^{{q}^{+}} = {lim}_{t \to ∞} {S}^{q ( t )} = ( 1 - α ) {( I - α {P}^{q} )}^{- 1} {S}^{( 0 )} \qquad ( 10 )$$

Then, the new similarity matrix for the qth feature type can be built by exploiting symmetry in the converged similarity matrix S [symbol] and removing small values (absolute values are smaller than a pre-defined threshold θ). The resulting similarity matrix is

$${\tilde{W}}^{q} = {⌊ \frac{{S}^{{q}^{+}} + {S}^{{q}^{+ 1}}}{2} ⌋}_{+ n} \qquad ( 11 )$$

However, since the computational overhead for the inversion problem is O(n³), it is very time consuming to calculate (I−αP)⁻¹ with direct methods for large scale images. Considering

$${( I - α P )}^{- 1} = I + {\sum }_{k = 0}^{∞} {α}^{k} {P}^{+} ,$$

we approximate the matrix inverse by using the first order term, which becomes (I−αP)⁻¹=I+αP with O(n²) computational complexity.

Finally, the regularizer in equation (4) is refined by updating {L^{q}}_{q=1}^{Q} based on the new set of similarity matrice {\tilde{W}^{q}}_{q=1}^{Q} at every update_step iteration as AL proceeds (when update_step=1, the regularizer is updated at every iteration), which exploits the increasing labeled information provided by the user.

After learning a low dimensional feature space, an active sampling strategy is needed to enrich the training set iteratively. In a batch-mode AL, both uncertainty and diversity need to be considered. The system quantifies the uncertainty of a pixel by considering a committee of classifiers, and the samples that exhibit the maximum disagreement between different models are selected. An uncertainty criterion is applied, in which the unlabeled samples are predicted using a committee of kNN classifiers, and each member is characterized by a different number of nearest neighbors, k.

The system also applies a diversity criterion to reduce the redundancy among the new queried samples. At a given AL iteration, we consider the following restrictions for sample selection: 1) samples that have completely identical label predictions from all the committee members with any already selected sample in the batch cannot be queried; and 2) any class cannot have more than S samples, where S is a user-defined parameter, and the class label is decided using majority voting based on the committee predictions. A schematic illustration of the proposed diversity criterion is shown in Table I. In this example, assume that the committee classifiers are defined as k={1, 3, 5}, the class labels are A, B, and C, and S is set to 2. Suppose in the current iteration, candidate samples {xⱼ}ⱼ₌₁^{Q} have the same degree of uncertainty. After selecting samples x₁, x₂, and x₃, sample x₄ and x₅ cannot be selected _{since}1) x₄ has the same label predictions as sample x₂ from all the three calssifiers; and 2) x₅ has the same majority voting label (label A) as x₁ and x₃. Sample x₆ can still be selected as it does not conflict with either of the two restrictions. Note that this criterion does not require clustering or other complicated techniques, but is simply based on the outputs of the committee kNN classifiers which can be accessed directly. Therefore, the final AL strategy includes two steps: uncertainty and diversity. A set of candidate unlabeled samples with the maximum degree of uncertainty are first considered based on the uncertainty criterion. Then, the diversity criterion is applied to select the most informative samples from the resulting contention pool.

TABLE I
Example of diversity criterion

| | | | | Query |
|---|---|---|---|---|
| | Predicted Labels | | | Decision |
| Candidate | [symbol] A; [symbol] B; [symbol] C | | | ✓ query |
| Samples | k = 1 | k = 3 | k = 5 | x not query |
| x₁ | [symbol] | [symbol] | [symbol] | ✓ |
| x₂ | [symbol] | [symbol] | [symbol] | ✓ |
| x₃ | [symbol] | [symbol] | [symbol] | ✓ |
| x₄ | [symbol] | [symbol] | [symbol] | x |
| x₅ | [symbol] | [symbol] | [symbol] | x |
| x₆ | [symbol] | [symbol] | [symbol] | ✓ |

Throughout this description, some aspects are described in terms that would ordinarily be implemented as software programs. Those skilled in the art will readily recognize that the equivalent of such software system 1040 are constructed in hardware, firmware, or micro-code. Because data-manipulation algorithms and systems are well known, the present description is directed in particular to algorithms and systems forming part of, or cooperating more directly with, systems and methods described herein. Other aspects of such algorithms and systems, and hardware or software for producing and otherwise processing signals or data involved therewith, not specifically shown or described herein, are selected from such systems, algorithms, component, and elements known in the art. Given the systems and methods as described herein, software not specifically shown, suggested, or described herein that is useful for implementation of any aspect is conventional and within the ordinary skill in such arts.

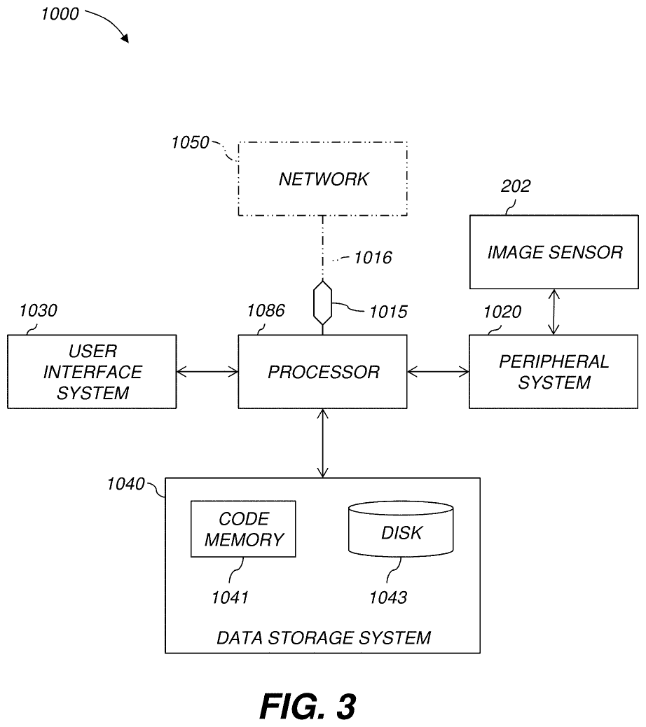

FIG. 3 is a high-level diagram showing the components of the exemplary system 1000 for analyzing the image data and performing other analyses described herein, and related components. The system 1000 includes a processor 1086, a peripheral system 1020, a user interface system 1030, and a data storage system 1040. The peripheral system 1020, the user interface system 1030 and the data storage system 1040 are communicatively connected to the processor 1086. Processor 1086 can be communicatively connected to network 1050 (shown in phantom), e.g., the Internet or a leased line, as discussed below. The image data may be received using image sensor 202 (via electrodes 204) and/or displayed using display units (included in user interface system 1030) which can each include one or more of systems 1086, 1020, 1030, 1040, and can each connect to one or more network(s) 1050. Image sensor 202 may comprise a digital imaging device, such as a digital camera, or the like. Processor 1086, and other processing devices described herein, can each include one or more microprocessors, microcontrollers, field-programmable gate arrays (FPGAs), application-specific integrated circuits (ASICs), programmable logic devices (PLDs), programmable logic arrays (PLAs), programmable array logic devices (PALs), or digital signal processors (DSPs).

Processor 1086 can implement processes of various aspects described herein. Processor 1086 can be or include one or more device(s) for automatically operating on data, e.g., a central processing unit (CPU), microcontroller (MCU), desktop computer, laptop computer, mainframe computer, personal digital assistant, digital camera, cellular phone, smartphone, or any other device for processing data, managing data, or handling data, whether implemented with electrical, magnetic, optical, biological components, or otherwise. Processor 1086 can include Harvard-architecture components, modified-Harvard-architecture components, or Von-Neumann-architecture components.

The phrase “communicatively connected” includes any type of connection, wired or wireless, for communicating data between devices or processors. These devices or processors can be located in physical proximity or not. For example, subsystems such as peripheral system 1020, user interface system 1030, and data storage system 1040 are shown separately from the data processing system 1086 but can be stored completely or partially within the data processing system 1086.

The peripheral system 1020 can include one or more devices configured to provide digital content records to the processor 1086. For example, the peripheral system 1020 can include digital still cameras, digital video cameras, cellular phones, or other data processors. The processor 1086, upon receipt of digital content records from a device in the peripheral system 1020, can store such digital content records in the data storage system 1040.

The user interface system 1030 can include a mouse, a keyboard, another computer (connected, e.g., via a network or a null-modem cable), or any device or combination of devices from which data is input to the processor 1086. The user interface system 1030 also can include a display device, a processor-accessible memory, or any device or combination of devices to which data is output by the processor 1086. The user interface system 1030 and the data storage system 1040 can share a processor-accessible memory.

In various aspects, processor 1086 includes or is connected to communication interface 1015 that is coupled via network link 1016 (shown in phantom) to network 1050. For example, communication interface 1015 can include an integrated services digital network (ISDN) terminal adapter or a modem to communicate data via a telephone line; a network interface to communicate data via a local-area network (LAN), e.g., an Ethernet LAN, or wide-area network (WAN); or a radio to communicate data via a wireless link, e.g., WiFi or GSM. Communication interface 1015 sends and receives electrical, electromagnetic or optical signals that carry digital or analog data streams representing various types of information across network link 1016 to network 1050. Network link 1016 can be connected to network 1050 via a switch, gateway, hub, router, or other networking device.

Processor 1086 can send messages and receive data, including program code, through network 1050, network link 1016 and communication interface 1015. For example, a server can store requested code for an application program (e.g., a JAVA applet) on a tangible non-volatile computer-readable storage medium to which it is connected. The server can retrieve the code from the medium and transmit it through network 1050 to communication interface 1015. The received code can be executed by processor 1086 as it is received, or stored in data storage system 1040 for later execution.

Data storage system 1040 can include or be communicatively connected with one or more processor-accessible memories configured to store information. The memories can be, e.g., within a chassis or as parts of a distributed system. The phrase “processor-accessible memory” is intended to include any data storage device to or from which processor 1086 can transfer data (using appropriate components of peripheral system 1020), whether volatile or nonvolatile; removable or fixed; electronic, magnetic, optical, chemical, mechanical, or otherwise. Exemplary processor-accessible memories include but are not limited to: registers, floppy disks, hard disks, tapes, bar codes, Compact Discs, DVDs, read-only memories (ROM), erasable programmable read-only memories (EPROM, EEPROM, or Flash), and random-access memories (RAMs). One of the processor-accessible memories in the data storage system 1040 can be a tangible non-transitory computer-readable storage medium, i.e., a non-transitory device or article of manufacture that participates in storing instructions that can be provided to processor 1086 for execution.

In an example, data storage system 1040 includes code memory 1041, e.g., a RAM, and disk 1043, e.g., a tangible computer-readable rotational storage device such as a hard drive. Computer program instructions are read into code memory 1041 from disk 1043. Processor 1086 then executes one or more sequences of the computer program instructions loaded into code memory 1041, as a result performing process steps described herein. In this way, processor 1086 carries out a computer implemented process. For example, steps of methods described herein, blocks of the flowchart illustrations or block diagrams herein, and combinations of those, can be implemented by computer program instructions. Code memory 1041 can also store data, or can store only code.

Various aspects described herein may be embodied as systems or methods. Accordingly, various aspects herein may take the form of an entirely hardware aspect, an entirely software aspect (including firmware, resident software, micro-code, etc.), or an aspect combining software and hardware aspects These aspects can all generally be referred to herein as a “service,” “circuit,” “circuitry,” “module,” or “system.”

Furthermore, various aspects herein may be embodied as computer program products including computer readable program code stored on a tangible non-transitory computer readable medium. Such a medium can be manufactured as is conventional for such articles, e.g., by pressing a CD-ROM. The program code includes computer program instructions that can be loaded into processor 1086 (and possibly also other processors), to cause functions, acts, or operational steps of various aspects herein to be performed by the processor 1086 (or other processor). Computer program code for carrying out operations for various aspects described herein may be written in any combination of one or more programming language(s), and can be loaded from disk 1043 into code memory 1041 for execution. The program code may execute, e.g., entirely on processor 1086, partly on processor 1086 and partly on a remote computer connected to network 1050, or entirely on the remote computer.

Those skilled in the art will recognize that numerous modifications can be made to the specific implementations described above. The implementations should not be limited to the particular limitations described. Other implementations may be possible.

What is claimed is:

1. A method of processing remotely sensed digital images, comprising:
receiving remotely sensed input image data, the input image data comprising a plurality of image features;
regularizing the input image data by applying a multimetric HMML active learning process which incorporates unlabeled data in the input data based on neighborhood relationships within the input data; and
updating similarity matrices in the HMML active learning process by incorporating supervised information in the dataset and iterating said regularizing to again regularize the input image data;
further processing the image data to output an image classification map, wherein said a set of unlabeled samples having a maximum degree of uncertainty are first considered based on an uncertainty criterion, after which a diversity criterion is applied to select the most informative samples from a resulting contention pool.
